(19) United States
(12) Patent Application Publication
(10) Pub. No.: US 2018/0338474 A1
(43) Pub. Date: Nov. 29, 2018

(54) RETRACTABLE LEASH FOR ROLLING UP AND UNROLLING A LEASH

(71) Applicant: Flexi - Bogdahn Technik GmbH & Co. KG, Bargteheide (DE)

(72) Inventors: Manfred BOGDAHN, Hamburg (DE); Thomas LAU, Neustadt in Holstein (DE)

(21) Appl. No.: 15/987,232

(22) Filed: May 23, 2018

(30) Foreign Application Priority Data
May 24, 2017 (DE) 10 2017 111 488.2

(51) Int. Cl. A01K 27/00; F16D 49/10; B65H 75/40; B65H 75/44

(52) U.S. Cl. CPC A01K 27/004; B65H 75/4431; B65H 75/406; F16D 49/10

(57) ABSTRACT

A retractable leash (10, 38) for rolling up and unrolling a leash (12), especially for leading an animal, with a leash roller (13), which is mounted rotatably on a carrier (11) and can be retracted by a retracting device into a rolled-up position, in which the leash (12) is wound up onto the leash roller (13); and with a blocking device for blocking the unrolling of the leash (12) from the leash roller (13), the radius of action of an animal being led can be effectively limited in a gentle and especially jerk-free manner by the blocking device having a brake (17) frictionally engaged with the leash roller (13) even in case of a bolting animal.

### CROSS REFERENCE TO RELATED APPLICATIONS

This application claims the benefit of priority under 35 U.S.C. § 119 of German Application 10 2017 111 488.2, filed May 24, 2017, the entire contents of which are incorporated herein by reference.

### FIELD OF THE INVENTION

The present invention pertains to a retractable leash for rolling up and unrolling a leash, especially for leading an animal, with a leash roller, which is mounted rotatably on a carrier and can be reset by means of resetting means into a rolled-up position, in which the leash is wound up onto the leash roller; and with blocking means for blocking the unrolling of the leash from the leash roller.

### BACKGROUND OF THE INVENTION

An animal, for example, a dog, can be safely and reliably led by a leading person by means of a retractable leash, because a leash connection to the animal can be maintained permanently. At the same time, the freedom of movement of the animal can be adapted to the particular conditions. In particular, the unrolling of the leash from the leash roller can be blocked in order to thus prevent a further distancing of the animal from the leading person.

Such a retractable leash is known from DE 10 2014 114 885 A1.

The drawback of the prior-art retractable leashes is that the blocking means used are usually catches and unrolling of the leash from the leash roller can only be blocked or released. When the animal is already moving more quickly away from the leading person or especially is threatening to bolt, this sudden blocking of the leash roller leads to a sometimes intense jerking in the leash. This is equally uncomfortable for the animal as for the leading person and may also lead to a fall or injury in case of lack of attention or in case of a weak or frail leading person.

### SUMMARY OF THE INVENTION

The object of the present invention is therefore to provide a retractable leash, with which the radius of action of an animal being led can be limited as gently as possible, preferably free from jerking, even in case of a bolting animal.

The object is accomplished in that in a retractable leash of the type mentioned in the introduction, the blocking means have a brake that is frictionally engaged with the leash roller.

By means of this frictionally engaged brake, an inoperative leash roller may be reliably blocked, on the one hand. When an animal being led is quickly distancing itself from the leading person or even is bolting, the movement of the animal can be slowed down to a stop in a gentle and especially jerk-free manner with the frictionally engaged brake.

A variant of the present invention is characterized in that the brake is a belt brake with a brake belt. The brake belt may preferably be configured as an elongated metal strip. Such a brake belt makes possible a simple configuration in the form of a looping of the leash roller or of a section thereof. A good application of force with likewise good heat dissipation can be guaranteed. In particular, the brake belt encloses the leash roller in a circumferential section. As a result, a reliable braking action is generated without undesired interaction with the leash. It is, in addition, advantageous when the circumferential section has a friction lining. As a result, the frictional action and thus the braking action can be increased with relatively little exertion of force of the leading person, which is especially advantageous for large and strong animals. Polyurethane is provided as material for the friction lining. Polyurethane generates an adequate friction and is sufficiently wear-resistant. The friction lining may be produced by means of a two-component injection molding process. This makes the production especially simple.

In a variant the brake belt has a first end section and a second end section facing away from the first end section. A fastening or an actuation of the brake belt is possible by means of these end sections. In particular, at least the first end section or the second end section is arranged on a tension bearing as an actuation section for the meshing of the brake belt with the friction lining. A fixed looping of the circumferential section with the brake belt can be achieved by pulling on the tension section, because especially the brake belt may easily transmit tensile forces. It is, in addition, advantageous when the first end section or the second end section is arranged on the carrier limited by a stop in its longitudinal motion. In particular, the first end section or the second end section may be arranged in a stationary manner on the carrier. In this way, there is a good fixing point against a pulling on the other end section, which makes possible a good and reliable application of force with a simple configuration.

Another variant is characterized in that a brake button is provided for actuating the brake. The brake button makes possible a simple operation. The brake button is preferably in active connection with the brake belt by means of a lever mechanism. In this way, a desired high braking action can be achieved in case of low actuation force of the brake button. It is thereby advantageous when the lever mechanism has a brake lever pivotable about an axis. This results in an especially simple and robust configuration.

In addition, it is advantageous when the brake lever has a double lever. In this way, the desired gear ratio can be set by the respective lever length in a structurally simple manner. The double lever may have two partial brake levers. The desired gear ratio can be assigned to the corresponding end section in this way. The partial brake levers may be arranged on sides of the axis facing away from one another. In this case, a tensile force can be fed to both end sections at the same time. However, it is also possible that a lever is configured with two tension bearings. In this case, a finer metered tightening of the brake belt can be guaranteed. It is especially advantageous when the partial brake levers have the same lever length. This results in an especially balanced application of force.

In another variant, a tension bearing which is tensioned by the brake belt has a shorter lever length than a tension bearing subject to pressure by the brake belt during the braking. This brings about a self-locking or a reinforcement of the braking force in case of a braking operation once it has been initiated.

Another variant of the present invention is again characterized in that the blocking means have two stages. In this way, a gentle braking can be combined with a forceful locking. In this connection, it is advantageous when the second stage has snap-in means for the positive-locking blocking of the unrolling. This positive-locking blocking brings about an especially high holding force with low effort of actuating force onto the blocking means. In particular, the snap-in means may interact with projections in the area of the outer circumference of the leash roller. This results in a high holding force with relatively low stress on the leash roller.

An advantageous embodiment is characterized by a coupling for triggering the second stage. In this way, the triggering of the first stage and the second stage can be controlled in a simple manner. At the same time, an undesired rattling is avoided due to the two-stage configuration because the first stage operates in a frictionally engaged manner and the second stage meshes abruptly after the coupling has been triggered. A slip coupling, a magnetic coupling or a ball end coupling may be used for this as a simple configuration. In the magnetic coupling, a certain magnetic force may also still be present after the triggering. As a result, a frictional engagement remains between the brake belt and the leash roller. An undesired noise development in the case of alternating stress on the leash can thus also be avoided in case of the positive-locking blocking. The configuration is especially simple when the magnetic coupling has levers which are magnetically coupled with one another. In this case, at least one lever may be part of the lever mechanism. A simple configuration is obtained when the ball end coupling has a recess and a ball in connection with it. The ball is preferably prestressed against the recess by means of a spring and is movable against the spring force for detaching the coupling. Such a configuration is reliable, robust and durable.

An advantageous variant is characterized by a locking button for locking the brake button in a braked position. The limitation of the radius of action of the animal being led can be maintained for a longer time without fatigue in this way. When a switching resistance has to be overcome to actuate the locking button, this makes an inadvertent operating error difficult. This switching resistance may be brought about by a lever actively connected to the locking button and having a projection. This results in a simple and reliable configuration. The projection may have a ball-end shape. As a result, an undesired large switching resistance can be avoided. The projection may interact with a carrier projection or a carrier recess. The carrier projection may be a carrier rib. In this way, the carrier projection or the carrier recess may already be produced in a simple manner during the production of the carrier, for example, during the injection molding process.

The present invention will be described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a first retractable leash with the features of the present invention with the left part of the housing removed;

FIG. 2 is a sectional view of the retractable leash from FIG. 1 with the leash roller removed;

FIG. 3 is an enlarged partial view of a coupling of the retractable leash from FIG. 1;

FIG. 4 is a sectional view of the area from FIG. 3 with the coupling triggered,

FIG. 5 is a schematic side view of another retractable leash with the right part of the housing removed as another exemplary embodiment of the present invention;

FIG. 6 is a schematic view of the essential elements of the blocking means of another embodiment with a different configuration of a coupling; and

FIG. 7 is a schematic view of another principle of action of a brake for a retractable leash with the features of the present invention.

### DESCRIPTION OF THE PREFERRED EMBODIMENTS

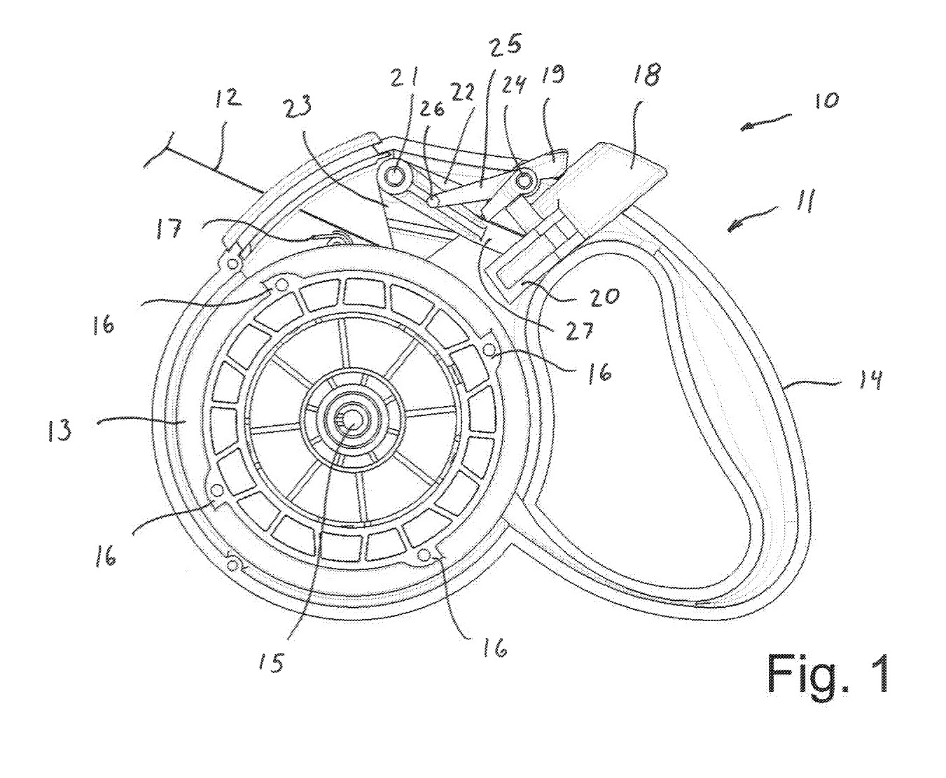

Referring to the drawings, FIG. 1 shows a schematic side view of a first retractable leash 10 with the features of the present invention with the left part of the housing removed. As can be seen in the figure, the retractable leash 10 has a housing 11, from which a leash 12 extends on the left-hand side at the top in the figure. The leash 12 is rolled up in the known manner onto a leash roller 13 arranged in the housing 11. The housing 11 has a handle 14 at its end facing away from the leash 12.

The leash roller 13 is mounted rotatably about an axis 15 and has projections 16 adjacent to its outer circumference. The projections 16 have a ramp-like configuration. A brake belt 17, which will be dealt with in more detail below, is arranged enclosing an outer circumferential section of the leash roller 13. The brake belt 17 is a strip of metal in the exemplary embodiment shown.

A brake button 18 and a locking button 19 extend outwards from the housing 11 adjacent to the handle 14. Associated with the brake button 18 is a snap-in section 20 arranged at an end of the brake button 18 facing the leash roller 13. The brake button 18 is displaceable in its longitudinal direction and is arranged elastically reset into the inoperative position shown in the housing 11.

In the housing 11 an actuating lever 22 and a brake lever 23 are arranged pivotably about an axis 21 and thus form a lever mechanism.

The locking button 19 is mounted pivotably about an axis 24 in the housing 11. The locking button 19 has an arm 25 in its extension going beyond the axis 24, at the end of the arm a projection 26 is arranged facing away from the axis 24. In the exemplary embodiment shown, the projection 26 has a ball-end-shaped configuration and interacts with a housing rib, which is not shown in the figure, on the inner side of the left part of the housing, which has been omitted. In this way, a precise pressure point is obtained when the locking lever 19 is actuated.

As can be further seen in the figure, an arm 27 is, moreover, mounted pivotably on the axis 21. The function of the arm 27 will be dealt with in more detail below.

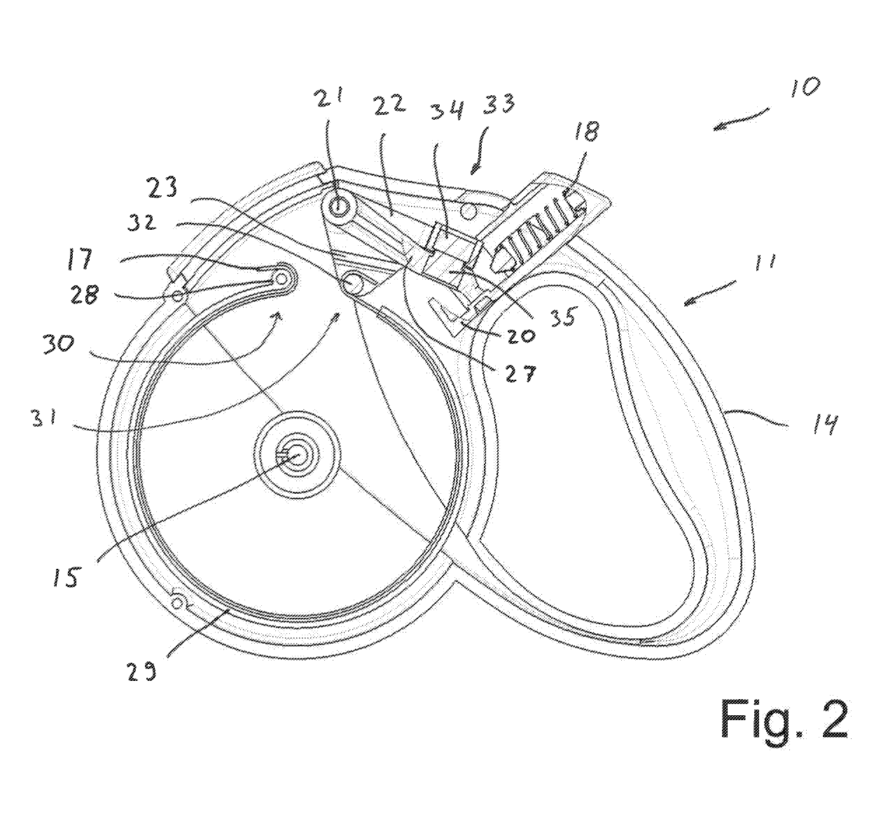

FIG. 2 shows a sectional view of the retractable leash from FIG. 1 with the leash roller removed. As can be seen in the figure, a first end section 30 of the brake belt is fixed to a fixed bearing 28 of the housing 11. Starting from the fixed bearing 28, an approximately circular rib 29 extends approximately concentrically about the axis 15. In the state shown, the brake belt 17 is in contact with the inner circumference of the rib 29.

A second end section 31, which is mounted on a tension bearing 32 at the brake lever 23, is provided at the end of the brake belt 17 facing away from the first end section.

A magnetic coupling 33 is formed by a magnet 34 and a piece of iron 35. The magnet 34 is arranged at the actuating lever 22. By contrast, the piece of iron 35 is arranged at the arm 27.

When the brake button 18 is actuated, the arm 27 is pivoted clockwise about the axis 21. Due to the magnetic action of the magnetic coupling 33, the magnet 34 is pivoted, in a clockwise manner in the figure, about an axis 21 together with the piece of iron 35. In this way, the actuating lever 22 and with this the brake lever 23, which are configured as a double lever in the exemplary embodiment shown, is also pivoted in a clockwise manner about the axis 21. The tension bearing 32 is moved in this way towards the left in the figure and pulls the second end section 31 of the brake belt 17 likewise towards the left in the figure. The circumference of the brake belt 17 is shortened in this manner and a braking action is exerted onto the circumferential section of the leash roller 13, with which the brake belt comes into active connection as a result. Depending on the actuation force exerted onto the brake button 18 by the thumb, such a braking force is produced onto the leash roller 13. In addition, there is a certain amount of self-locking due to the frictional engagement of the leash roller 13 and the brake belt 17, which brings about a tightening of the brake belt 17 on the leash roller 13. If a predefined actuating force is exceeded, the magnetic coupling 33 is triggered, as will be explained in more detail below.

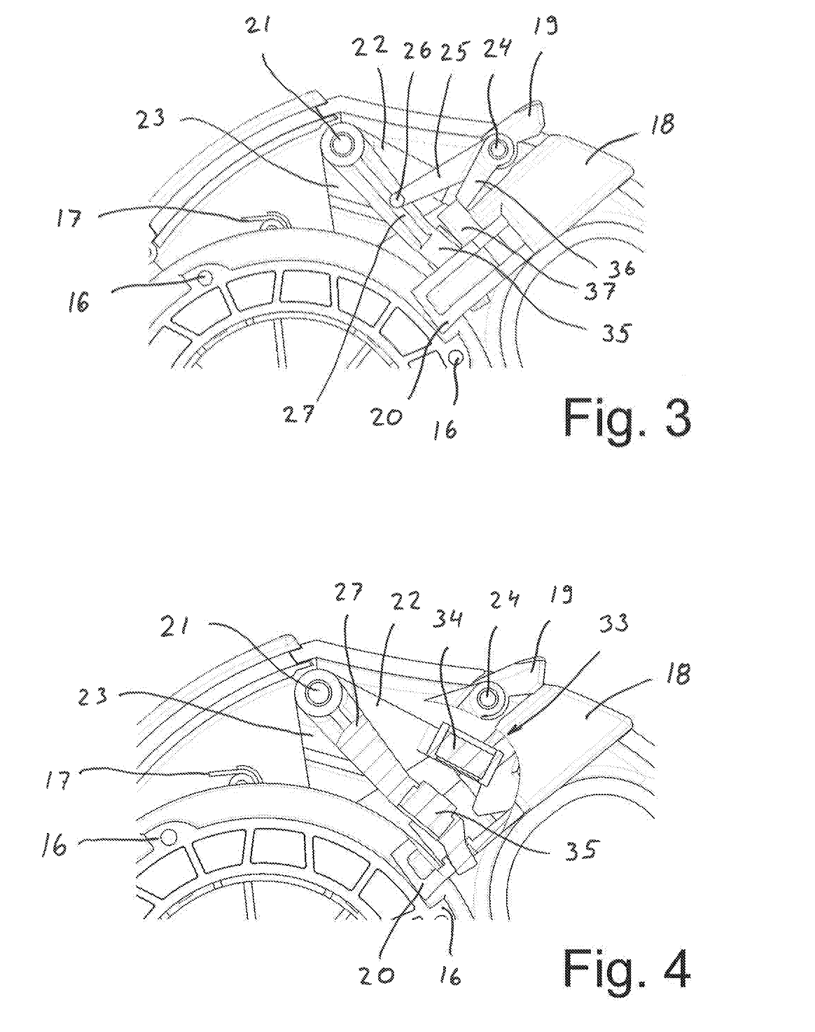

FIG. 3 shows an enlarged partial view of the coupling 33 of the retractable leash 10 from FIG. 1. As can be seen in the figure, the locking button 19 has, in addition, a locking section 36, which has a lever-like configuration and is likewise pivotable with the locking button 19 about the axis 24. The brake button 18 has a projection 37 facing the locking section 36. In the state shown, the brake button 18 is depressed in its longitudinal direction up to the leash roller 13 and the locking button 19 is pivoted, in a counterclockwise manner in the figure, about the axis 24 for locking the brake button. In this way, the locking section 36 is brought into contact with the projection 37, so that springing back of the brake button 18 is prevented due to abutting of the projection 37 against the locking section 36.

FIG. 4 shows a sectional view of the area from FIG. 3 with the coupling 33 triggered. Shown is a partially cutaway view, on the basis of which the principle of operation of the coupling 33 shall be explained. As already explained, the brake button 18 is depressed up to the leash roller 13 in the state shown. In this case, the maximum holding force of the coupling 33, which is predefined by the magnet 34 and the piece of iron 35, has been exceeded. The coupling 33 has as a result been triggered and the piece of iron 35 depressed with the brake button 18 has been released by the magnet 34. In this case, the magnet 34 partially springs back to the lever 22 about the axis 21 due to the resetting spring force of the brake belt 17, which is configured as a metal strip, but is still pulled due to the magnetic force between the magnet 34 and the piece of iron 35 provided that the frictional engagement between the brake belt 17 and the leash roller 13 is preserved. The brake resistance on the brake button 18 falls suddenly and the brake button 18 is depressed unhindered until the snap-in section 20 rests on the leash roller 13. In this state, the next projection 16 stops at the snap-in section 20 in case of the further unrolling of the leash roller 13 and thus blocks a further unrolling of the leash 12 from the leash roller 13. The leash roller is reliably blocked with low holding force against further unrolling of the leash 12 from the leash roller 13.

A rattling of the retractable leash 10 does not occur when the brake button is actuated because of the frictionally engaged braking action with the brake belt 17. Rattling likewise does not occur when the leash roller 13 is locked with the snap-in section 20 because the snap-in section 20 moves into its snapped-in position in a jerk-like manner after the magnetic coupling 33 has been triggered. In addition, since the leash roller 13 also remains frictionally engaged with the brake belt in the locked state due to the magnetic force between the magnet 34 and the piece of iron 35, no undesired noise development due to abutting of the snap-in section 20 on projections 16, which are adjacent to one another, is possible even in case of alternating stresses on the leash 12.

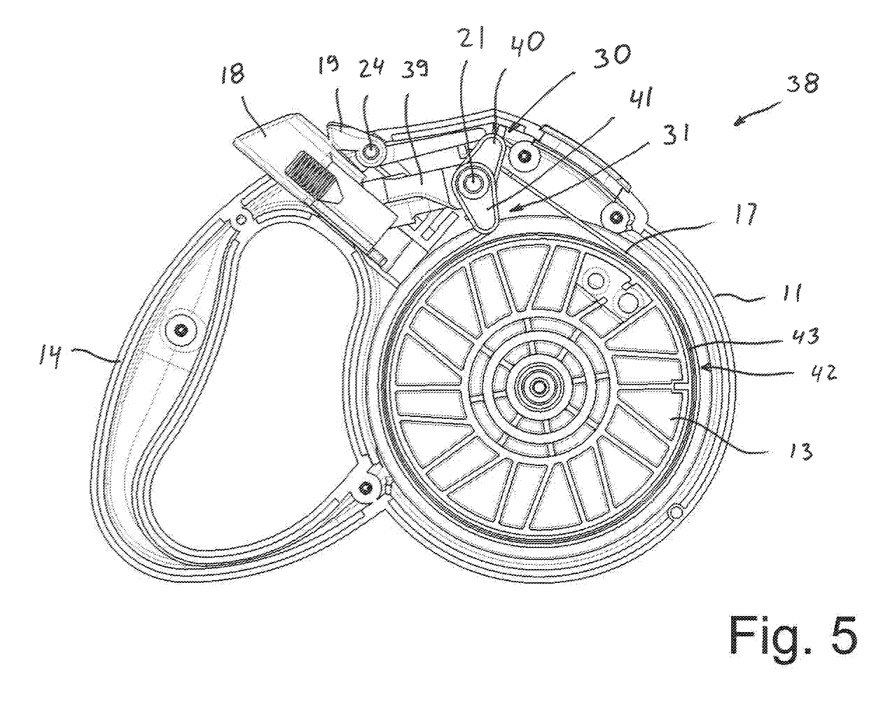

FIG. 5 shows a schematic side view of another retractable leash 38 with the right part of the housing removed as another exemplary embodiment of the present invention. In terms of its configuration, the retractable leash 38 corresponds essentially to the retractable leash 10. Identical components have the same reference numbers. By contrast to the retractable leash 10, the retractable leash 38 has, instead of the actuating lever 22, an actuating lever 39, which is arranged pivotably about the axis 21. The actuating lever 39 is driven with the brake button 18 as in the case of the retractable leash 10.

At the end of the actuating lever 39 facing away from the brake button 18, the actuating lever is connected non-rotatably to brake levers 40, 41, which are likewise pivotable about the axis 21.

Unlike in the retractable leash 10, the first end section 30 of the brake belt 17 is not arranged on a fixed bearing, but rather on a tension bearing, not shown in the figure, at the brake lever 40. In a similar manner, the second end section 31 is arranged at a tension bearing, which is likewise not shown in the figure, at the brake lever 41. When the brake button 18 is actuated, both end sections 30, 31 in the retractable leash 38 are thus driven to form a more fixed looping of the circumferential section of the leash roller 13 when the brake button is depressed.

In addition, the circumferential section 42 of the leash roller 13 can be seen in the figure. The circumferential section 42 has a friction lining 43 for an improvement in the frictional engagement. In the exemplary embodiment shown, the friction lining 43 is made of polyurethane and is produced with the leash roller 13 in a two-component injection molding process.

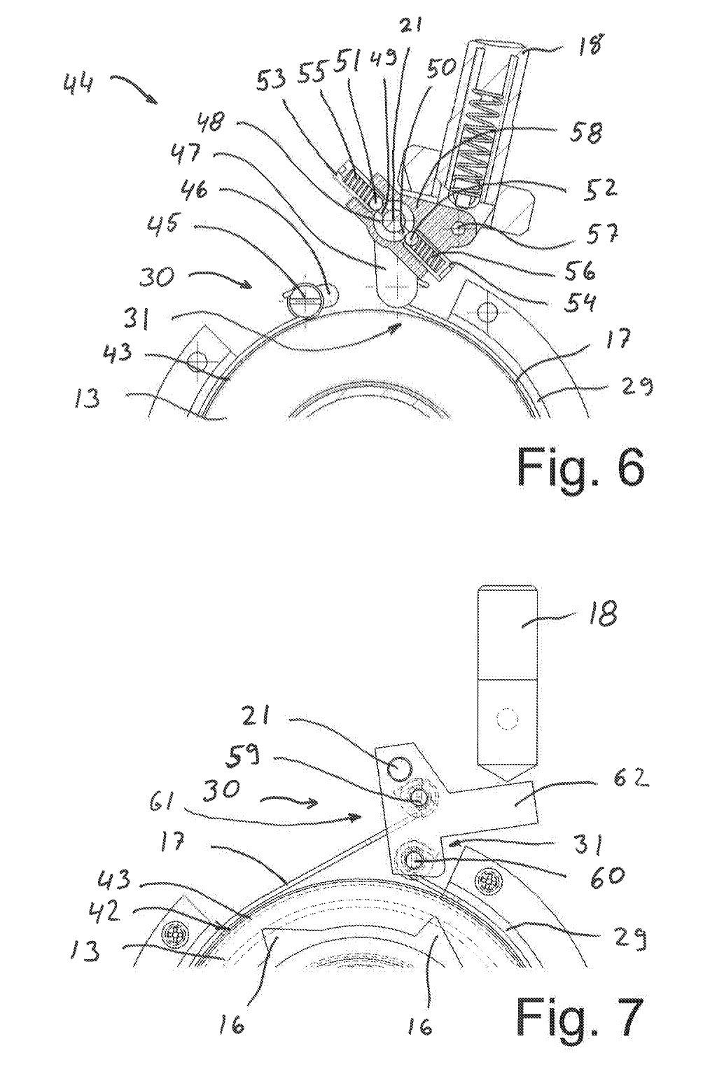

FIG. 6 shows a schematic view of the essential components of the blocking means of another embodiment with a different configuration of a coupling 44. In terms of its mode of operation, this embodiment essentially corresponds to the retractable leashes 10 and 38. Identical components have the same reference numbers.

As can be seen in the figure, the first end section 30 is fastened to a screw 45, which is guided in an elongated hole 46. In this manner, the function similar to the fixed bearing 28 is obtained, wherein, when the brake belt is relaxed, the screw 45 can slide into the elongated hole 46 towards the right in the figure. In this manner, a greater free space between the brake belt 17 and the circumferential section 42 is guaranteed in the non-actuated state of the brake button 18.

In the exemplary embodiment shown, the second end section 31 is arranged on a tension bearing, which is not shown in the figure and which is arranged at the end of the brake lever 47 facing away from the axis 21. The brake lever 47 has the axis 21 enclosing a cylinder 48 at its end facing away from the tension bearing.

The coupling 44 is a ball end coupling 44. The ball end coupling has holes 49, 50 on circumferential sides of the cylinder 48, which sides are facing away from one another. Associated with each of the holes 49, 50 are provided balls 51, 52, which are arranged in the sleeves 53, 54. The balls 51, 52 are each prestressed onto the holes 49, 50 by means of springs 55, 56 in the sleeves 53, 54.

The brake button 18 is connected pivotably to a holder 58 by means of a bolt 57. The holder 58 in turn is pivotable about the axis 21 and is used for fastening the sleeves 53, 54.

When the brake button 18 is actuated, the holder 58 is pivoted in a clockwise manner in the figure. Due to the balls 51, 52 prestressed into the holes 49, 50 by means of the springs 55, 56, a torque is transmitted to the cylinder 48. As a result, the brake lever 47 is likewise pivoted in a clockwise manner in the figure and pulls the second end section 31 of the brake belt 17 over the tension bearing towards the left in the figure. The screw 45 may in this case deviate so far to the left in the figure as this is possible due to the elongated hole 46. If the screw 45 stops at the left edge of the elongated hole 46 in the figure, the screw 45 acts, furthermore, as a fixed bearing for the first end section 30. The brake belt is then secured on the circumferential section 42 of the leash roller 13 and brings about the braking of the rotary motion.

When the coupling force determined by the ball end coupling 44 is exceeded, the coupling force is 25 N in the present exemplary embodiment, the balls 51, 52 slide back out of the holes 49, 50 against the spring force of the springs 55, 56 and then roll off on the cylinder 48. Further transmission of force from the brake button 18 to the brake lever 47 and thus to the second end section 31 is then no longer possible and locking follows in the manner already described above.

FIG. 7 shows a schematic view of another principle of operation of a brake for a retractable leash with the features of the present invention. The principle of operation shown essentially corresponds to that of the retractable leashes 10, 38. Identical components have the same reference numbers. Unlike in the retractable leash 38, the exemplary embodiment shown has a first tension bearing 59 for the first end section 30 and a second tension bearing 60 for the second end section 31. Unlike in the retractable leash 38, the first tension bearing 59 and the second tension bearing 60 are arranged at the same brake lever 61, which together with the actuating lever 62 is pivotable about the axis 21. In the exemplary embodiment shown, the first tension bearing 59 is arranged at a shorter distance to the axis 21 at the brake lever 61 than the second tension bearing 60. When the leash roller 13 in this case is rotated in a counterclockwise manner in the figure due to pulling of an animal being led and the brake button 18 is pressed downwards in the figure, the actuating lever 62 is as a result pivoted in a clockwise manner in the figure about the axis 21. As a result, the brake lever 61 and the tension bearings 59, 60 located on it are likewise pivoted in a clockwise manner in the figure. In this case, the first tension bearing 59 releases the first end section 30 arranged on it to some extent, while the second tension bearing 60 pulls the second end section 31 arranged on it more intensely. The path of the second tension bearing 60 thereby traveled for tightening the brake belt 17 is greater than the path of the first tension bearing 59 traveled, because the second tension bearing 60 has a greater radial distance from the axis 21 than the first tension bearing 59. In this manner, the desired amount of self-locking can be achieved by a corresponding coordination of the radial distances of the tension bearings 59, 60 from the axis 21.

While specific embodiments of the invention have been shown and described in detail to illustrate the application of the principles of the invention, it will be understood that the invention may be embodied otherwise without departing from such principles.

### LIST OF REFERENCE NUMBERS

| | |
|---|---|
| 10 | Retractable leash |
| 11 | Housing |
| 12 | Leash |
| 13 | Leash roller |
| 14 | Handle |
| 15 | Axis |
| 16 | Projection |
| 17 | Brake belt |
| 18 | Brake button |
| 19 | Locking button |
| 20 | Snap-in section |
| 21 | Axis |
| 22 | Actuating lever |
| 23 | Brake lever |
| 24 | Axis |
| 25 | Arm |
| 26 | Projection |
| 27 | Arm |
| 28 | Fixed bearing |
| 29 | Rib |
| 30 | First end section |
| 31 | Second end section |
| 32 | Tension bearing |
| 33 | Magnetic coupling |
| 34 | Magnet |
| 35 | Piece of iron |
| 36 | Locking section |
| 37 | Projection |
| 38 | Retractable leash |
| 39 | Actuating lever |
| 40 | Brake lever |
| 41 | Brake lever |
| 42 | Circumferential section |
| 43 | Friction lining |
| 44 | Ball end coupling |
| 45 | Screw |
| 46 | Elongated hole |
| 47 | Brake lever |
| 48 | Cylinder |
| 49 | Hole |
| 50 | Hole |
| 51 | Ball |
| 52 | Ball |
| 53 | Sleeve |
| 54 | Sleeve |
| 55 | Spring |
| 56 | Spring |
| 57 | Bolt |
| 58 | Holder |
| 59 | Tension bearing |
| 60 | Tension bearing |
| 61 | Brake lever |
| 62 | Actuating lever |

What is claimed is:

1. A retractable leash for rolling up and unrolling a leash, the retractable leash comprising:
a leash roller mounted rotatably on a carrier, the leash roller being reset via a resetting means into a rolled-up position, in which the leash is wound up onto the leash roller;
a blocking means for blocking unrolling of the leash from the leash roller, the blocking means having a brake, the brake being frictionally engaged with the leash roller.

2. A retractable leash in accordance with claim 1, wherein the brake is a belt brake with a brake belt, the brake belt being configured as an elongated strip of metal, the elongated strip of metal enclosing the leash roller in a circumferential section, the circumferential section having a friction lining, the friction lining comprising polyurethane, wherein the friction lining is produced according to a two-component injection molding process.

3. A retractable leash in accordance with claim 2, wherein the brake belt has a first end section and a second end section facing away from the first end section, at least one of the first end section and the second end section being arranged on a tension bearing as an actuating section for meshing the brake belt with the friction lining, wherein at least one of the first end section and the second end section is arranged limited by a stop in a longitudinal movement of the at least one of the first end section and the second end section in a stationary manner on the carrier.

4. A retractable leash in accordance with claim 2, wherein a brake button is provided for actuating the brake, the brake button being operatively connected with the brake belt by a lever mechanism, wherein the lever mechanism has a brake lever pivotable about an axis.

5. A retractable leash in accordance with claim 4, wherein the brake lever comprises a double lever with two partial brake levers that are arranged on sides of the axis facing away from one another and the two partial brake levers have a same lever length.

6. A retractable leash in accordance with claim 5, wherein a tension bearing tensioned by the brake belt during braking has a shorter lever length than another tension bearing subjected to pressure by the brake belt during the braking.

7. A retractable leash in accordance with claim 4, wherein the blocking means has two stages and a snap-in means for positive-locking blocking of the unrolling of the leash from the leash roller, the snap-in means interacting with projections in an area of an outer circumference of the leash roller as a second stage of the two stages.

8. A retractable leash in accordance with claim 7, further comprising a coupling for triggering the second stage, the coupling comprising one of a slip clutch, a magnetic coupling comprising levers magnetically coupled to one another with at least one of the levers being part of the lever mechanism and a ball end coupling comprising a recess and a ball in connection with the recess and the ball being prestressed by a spring against the recess and the ball is movable against a force of the spring for detaching the ball end coupling.

9. A retractable leash in accordance with claim 4, further comprising a locking button for locking the brake button in a braked position, wherein a lever is configured for actuating the locking button such that a switching resistance is overcome, the lever having a ball-end-shaped projection operatively connected with the locking button, the lever interacting with a carrier projection or with a carrier recess.

10. A retractable leash for rolling up and unrolling a leash, the retractable leash comprising:
a carrier;
a leash roller rotatably mounted on the carrier
a resetting mechanism configured to reset the leash roller to a rolled-up position, wherein the leash is wound about the leash roller in the rolled-up position;
a blocking mechanism configured to prevent unrolling of the leash from the leash roller, the blocking mechanism comprising a brake, the brake being in contact with the leash roller.

11. A retractable leash in accordance with claim 10, wherein the brake comprises a belt brake with a brake belt, the brake belt comprising an elongated strip of metal, the brake belt enclosing a circumferential section of the leash roller, the circumferential section having a friction lining, the friction lining comprising polyurethane, wherein the friction lining is produced via a two-component injection molding process.

12. A retractable leash in accordance with claim 11, wherein the brake belt has a first end section and a second end section facing away from the first end section, at least one of the first end section and the second end section being arranged on a tension bearing as an actuating section for meshing the brake belt with the friction lining, wherein at least one of the first end section and the second end section is arranged limited by a stop in a longitudinal movement of the at least one of the first end section and the second end section in a stationary manner on the carrier.

13. A retractable leash in accordance with claim 11, further comprising a brake button for actuating the brake, the brake button being operatively connected with the brake belt by a lever mechanism, wherein the lever mechanism has a brake lever pivotable about an axis.

14. A retractable leash in accordance with claim 13, wherein the brake lever comprises a double lever with two partial brake levers that are arranged on sides of the axis facing away from one another and the two partial brake levers have a same lever length.

15. A retractable leash in accordance with claim 14, wherein the blocking mechanism comprises a first tension bearing and a second tension bearing, wherein the first tension bearing is tensioned by the brake belt during braking and the second tension bearing is subjected to pressure by the brake belt during the braking, the first tension bearing having a shorter lever length than the second tension bearing.

16. A retractable leash in accordance with claim 13, wherein the blocking mechanism has a first stage, a second stage and a snap-in means for positive-locking blocking of the unrolling of the leash from the leash roller, the first stage comprising the brake being frictionally engaged with the leash roller, the snap-in means interacting with projections in an area of an outer circumference of the leash roller as the second stage.

17. A retractable leash in accordance with claim 16, further comprising a coupling for triggering the second stage, the coupling comprising one of:
a slip clutch;
a magnetic coupling comprising levers magnetically coupled to one another, at least one of the levers being part of the lever mechanism; and
a ball end coupling comprising a recess and a ball in connection with the recess and the ball being prestressed by a spring against the recess, the ball being movable against a force of the spring for detaching the ball end coupling.

18. A retractable leash in accordance with claim 13, further comprising a locking button for locking the brake button in a braked position, wherein a lever is configured for actuating the locking button such that a switching resistance is overcome, the lever having a ball-end-shaped projection operatively connected with the locking button, the lever interacting with a carrier projection or with a carrier recess.
